(19) United States
(12) Patent Application Publication
(10) Pub. No.: US 2025/0363020 A1
(43) Pub. Date: Nov. 27, 2025

(54) SERVERLESS ARCHITECTURE DISTRIBUTED FAULT-TOLERANT SYSTEM AND METHOD, APPARATUS, DEVICE, AND MEDIUM

(71) Applicants: DOUYIN VISION CO., LTD., Beijing (CN); Lemon Inc., Grand Cayman (KY)

(72) Inventors: Lin MA, Los Angeles, CA (US); Haiyang SHI, Los Angeles, CA (US); Jinlai XU, Los Angeles, CA (US); Peng LIN, Los Angeles, CA (US); Kai WU, Los Angeles, CA (US); Xiao LIU, Los Angeles, CA (US); Wei XU, Los Angeles, CA (US); Dawei GONG, Los Angeles, CA (US); Hongzhi CHEN, Beijing (CN); Shuai ZHANG, Beijing (CN)

(21) Appl. No.: 18/872,262

(22) PCT Filed: Aug. 7, 2023
(86) PCT No.: PCT/CN2023/111562

§ 371 Date: Dec. 5, 2024

(30) Foreign Application Priority Data
Aug. 23, 2022 (CN) 202211010834.1

(51) Int. Cl. G06F 11/20

(52) U.S. Cl. CPC G06F 11/2023; G06F 11/2046; G06F 2201/84

(57) ABSTRACT

The present disclosure provides a serverless architecture distributed fault-tolerant system and method, an apparatus, a device, and a medium. The system comprises: a serverless architecture control module and distributed architecture-based computing nodes. The serverless architecture control module monitors a working state of distributed architecture-based computing nodes, and in response to monitoring a faulty computing node, constructs a replica computing node for the faulty computing node based on a persistent storage unit in the faulty computing node. The replica computing node replaces the faulty computing node to continue to execute a target task undertaken by the faulty computing node. The replica computing node restores an execution of the target task based on graph data and state snapshot data corresponding to the target task that are stored in the persistent storage unit.

### CROSS-REFERENCE TO RELATED APPLICATION(S)

The present disclosure is a U.S. National Stage Application under 35 U.S.C. §371 of International Patent Application No. PCT/CN2023/111562, filed on Aug. 7, 2023, which is based on and claims priority of Chinese application No. 202211010834.1, filed on Aug. 23, 2022, the disclosures of both of which are hereby incorporated into this disclosure by reference in their entireties.

### TECHNICAL FIELD

The present disclosure relates to the field of data processing, and in particular, to a serverless architecture distributed fault-tolerant system and method, an apparatus, a device, and a storage medium.

### BACKGROUND

With the maturity of technologies such as cloud, big data, and containers, a serverless (Serverless) architecture emerges as the times require. Under the Serverless architecture, a user only needs to focus on code implementation of application logic, and deployment and maintenance of infrastructure such as a server and elastic scaling of computing resources are all performed by a Serverless platform. A serverless architecture distributed processing system is usually large-scale.

### SUMMARY

In a first aspect, the present disclosure provides a serverless architecture distributed fault-tolerant system. The system comprises:

a serverless architecture control module and distributed architecture-based computing nodes, wherein:

the serverless architecture control module is in communication connection with the distributed architecture-based computing nodes; the distributed architecture-based computing nodes are configured to receive and execute an assigned target task;

the serverless architecture control module is configured to monitor a working state of the distributed architecture-based computing nodes, and in a response to monitoring a faulty computing node, construct a replica computing node for the faulty computing node based on a persistent storage unit in the faulty computing node;

the replica computing node is configured to replace the faulty computing node to continue to execute a target task assigned to the faulty computing node;

the persistent storage unit is configured to store graph data and state snapshot data corresponding to the target task, and the state snapshot data comprises intermediate state data generated during execution of the target task; and

the replica computing node is configured to restore an execution of the target task based on the graph data and the state snapshot data corresponding to the target task that are stored in the persistent storage unit.

In some embodiments, the serverless architecture control module is configured to construct a proxy unit for the persistent storage unit in the faulty computing node; and

the constructed proxy unit is configured to construct a computing unit for the persistent storage unit in the faulty computing node, the replica computing node comprises the constructed computing unit and the proxy unit, and control the constructed computing unit to restore the execution of the target task based on the state snapshot data and the graph data corresponding to the target task that are stored in the persistent storage unit in the faulty computing node.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises the intermediate state data generated during the execution of the target task, and the system further comprises:

a master proxy unit, wherein the master proxy unit is in communication connection with the proxy unit in the each of the distributed architecture-based computing nodes;

the master proxy unit is configured to monitor a working state of the proxy unit in the each of the distributed architecture-based computing nodes, and in response to monitoring a faulty proxy unit, construct a replica proxy unit for the faulty proxy unit; and

the replica proxy unit is configured to construct a computing unit corresponding to the faulty proxy unit for the persistent storage unit corresponding to the faulty proxy unit, and control the constructed computing unit corresponding to the faulty proxy unit to restore the execution of the target task based on the state snapshot data and the graph data of the target task that are stored in the persistent storage unit corresponding to the faulty proxy unit.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises the intermediate state data generated during the execution of the target task; and

the proxy unit is configured to create a replica computing unit for a faulty computing unit, and in response to the proxy unit monitoring the faulty computing unit, control the replica computing unit to replace the faulty computing unit to restore the execution of the target task based on the state snapshot data and the graph data of the target task that are stored in the persistent storage unit corresponding to the faulty computing unit.

In some embodiments, the constructed proxy unit is further configured to notify, based on a communication connection between proxy units, a proxy unit in another computing node to suspend execution of the assigned target task, and in response to restoring the execution of the target task, notify the proxy unit in the another computing node to continue to execute the assigned target task.

In some embodiments, the constructed proxy unit is specifically configured to construct a computing unit for the persistent storage unit in the faulty computing node, and control the constructed computing unit to restore the execution of the target task based on the state snapshot data, the graph data corresponding to the target task, and the state snapshot data from another computing node that are stored in the persistent storage unit in the faulty computing node.

In some embodiments, the persistent storage unit uses a hierarchical structure of a memory, a persistent storage medium, and a hard disk, and

the persistent storage unit is specifically configured to store the graph data and the state snapshot data corresponding to the target task in corresponding storage layers based on a descending order of priorities of three storage layers of the memory, the persistent storage medium, and the hard disk.

In some embodiments, the persistent storage unit uses a hierarchical structure of a memory and a persistent storage medium, and

the persistent storage unit is specifically configured to store the graph data and the state snapshot data corresponding to the target task in corresponding storage layers based on a descending order of priorities of two storage layers of the memory and the persistent storage medium.

In some embodiments, the persistent storage medium comprises a persistent memory.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task; and the system further comprises a master proxy unit, wherein the master proxy unit is in communication connection with the proxy unit in each of the distributed architecture-based computing nodes;

the master proxy unit is configured to monitor a working state of the proxy unit in the each of the distributed architecture-based computing nodes, and in response to monitoring a faulty proxy unit, construct a replica proxy unit for the faulty proxy unit; and

the replica proxy unit is configured to construct a computing unit corresponding to the faulty proxy unit for the persistent storage unit corresponding to the faulty proxy unit, and control the constructed computing unit corresponding to the faulty proxy unit to restore the execution of the target task based on the state snapshot data and the graph data of the target task that are stored in the persistent storage unit corresponding to the faulty proxy unit; and

the proxy unit is configured to create a replica computing unit for a faulty computing unit, and in response to monitoring the faulty computing unit, control the replica computing unit to replace the faulty computing unit to restore the execution of the target task based on the state snapshot data and the graph data of the target task that are stored in the persistent storage unit.

In a second aspect, the present disclosure further provides a serverless architecture distributed fault-tolerant method. The method comprises:

monitoring a working state of distributed architecture-based computing nodes, and in a response to monitoring a faulty computing node, constructing a replica computing node for the faulty computing node based on a persistent storage unit in the faulty computing node, wherein the replica computing node is configured to replace the faulty computing node to continue to execute a target task assigned to the faulty node, the persistent storage unit is configured to store graph data and state snapshot data corresponding to the target task, and the state snapshot data comprises intermediate state data generated during execution of the target task; and

controlling the replica computing node to restore an execution of the target task based on the state snapshot data and the graph data corresponding to the target task that are stored in the persistent storage unit.

In some embodiments, the constructing a replica computing node for the faulty computing node based on a persistent storage unit in the faulty computing node comprises:

constructing a proxy unit for the persistent storage unit in the faulty computing node; and

controlling the constructed proxy unit to construct a computing unit for the persistent storage unit in the faulty computing node; and

the controlling the replica computing node to restore the execution of the target task based on the state snapshot data and the graph data corresponding to the target task that are stored in the persistent storage unit comprises:

controlling, by using the constructed proxy unit, the constructed computing unit to restore the execution of the target task based on the state snapshot data and the graph data corresponding to the target task that are stored in the persistent storage unit in the faulty computing node.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task, and the method further comprises:

monitoring a working state of the proxy unit in the each of the distributed architecture-based computing nodes by using a master proxy unit, and in response to monitoring a faulty proxy unit, constructing a replica proxy unit for the faulty proxy unit; and

controlling the replica proxy unit to construct the computing unit corresponding to the faulty proxy unit for the persistent storage unit corresponding to the faulty proxy unit, and controlling the constructed computing unit corresponding to the faulty proxy unit to restore the execution of the target task based on the state snapshot data and the graph data of the target task that are stored in the persistent storage unit corresponding to the faulty proxy unit.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task, and the method further comprises:

in response to a proxy unit in a computing node monitoring faulty computing unit in the computing node, creating a replica computing unit for the faulty computing unit; and

controlling the replica computing unit to replace the faulty computing unit to restore the execution of the target task based on the state snapshot data and the graph data of the target task that are stored in the persistent storage unit in the computing node.

In some embodiments, the method further comprises:

notifying, by using the constructed proxy unit and based on a communication connection between proxy units, another proxy unit to suspend execution of the target task; and

in response to monitoring that the execution of the target task is restored, notifying the proxy unit in the another computing node to continue to execute the assigned target task.

In some embodiments, t the controlling, by using the constructed proxy unit, the constructed computing unit to restore the execution of the target task based on the state snapshot data and the graph data corresponding to the target task that are stored in the persistent storage unit in the faulty computing node comprises:

controlling, by using the constructed proxy unit, the constructed computing unit to restore the execution of the target task based on the state snapshot data, the graph data corresponding to the target task that are stored in the persistent storage unit in the faulty computing node, and the state snapshot data from another computing node.

In some embodiments, the method further comprises:

monitoring a working state of a proxy unit in each of the distributed architecture-based computing nodes by using a master proxy unit, and in response to monitoring a faulty proxy unit, constructing a replica proxy unit for the faulty proxy unit; controlling the replica proxy unit to construct a computing unit corresponding to the faulty proxy unit for the persistent storage unit corresponding to the faulty proxy unit, and controlling the constructed computing unit corresponding to the faulty proxy unit to restore the execution of the target task based on the state snapshot data and the graph data of the target task that are stored in the persistent storage unit corresponding to the faulty proxy unit; and

in response to a proxy unit in a computing node monitoring a faulty computing unit in the computing node, creating a replica computing unit for the faulty computing unit; and controlling the replica computing unit to replace the faulty computing unit to restore the execution of the target task based on the state snapshot data and the graph data of the target task that are stored in the persistent storage unit in the faulty computing node.

In a third aspect, the present disclosure further provides a serverless architecture distributed fault-tolerant apparatus. The apparatus comprises:

a first construction module, configured to monitor a working state of distributed architecture-based computing nodes, and in a response to monitoring a faulty computing node, constructing a replica computing node for the faulty compute node based on a persistent storage unit in the faulty computing node, wherein the replica computing node is configured to replace the faulty computing node to continue to execute a target task assigned to the faulty node, the persistent storage unit is configured to store graph data and state snapshot data corresponding to the target task, and the state snapshot data comprises intermediate state data generated during execution of the target task; and

a first restore execution module, configured to control the replica computing node to restore an execution of the target task based on the state snapshot data and the graph data corresponding to the target task that are stored in the persistent storage unit.

In a fourth aspect, the present disclosure provides a non-transitory computer-readable storage medium storing instructions that, when executed on a terminal device, cause the terminal device to implement the method described above.

In a fifth aspect, the present disclosure provides a data processing device, comprising a memory, a processor, and a computer program stored in the memory and executable on the processor. When the processor executes the computer program, the serverless architecture distributed fault-tolerant method in any one of the foregoing embodiments is implemented.

In a sixth aspect, the present disclosure provides a computer program product comprising a computer program/instructions that, when executed by a processor, cause the serverless architecture distributed fault-tolerant method in any one of the foregoing embodiments to be implemented.

In a seventh aspect, the present disclosure provides a computer program comprising instructions that, when executed by a processor, cause the processor to implement the serverless architecture distributed fault-tolerant method described in any one of the foregoing embodiments.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the technical solutions in the embodiments of the present disclosure or in the prior art, the following briefly describes the accompanying drawings required for describing the embodiments or the prior art. Obviously, those of ordinary skill in the art can still derive other drawings from these accompanying drawings without creative efforts.

FIG. 1 is an architecture diagram of a serverless architecture distributed fault-tolerant system according to an embodiment of the present disclosure;

FIG. 2 is an architecture diagram of another serverless architecture distributed fault-tolerant system according to an embodiment of the present disclosure;

FIG. 3 is a schematic diagram of still another serverless architecture distributed fault-tolerant system according to an embodiment of the present disclosure;

FIG. 4 is a schematic diagram of still another serverless architecture distributed fault-tolerant system according to an embodiment of the present disclosure;

FIG. 5 is a flowchart of a serverless architecture distributed fault-tolerant method according to an embodiment of the present disclosure;

FIG. 6 is a schematic diagram of a structure of a serverless architecture distributed fault-tolerant apparatus according to an embodiment of the present disclosure; and

FIG. 7 is a schematic diagram of a structure of a serverless architecture distributed fault-tolerant device according to an embodiment of the present disclosure.

### DETAILED DESCRIPTION

In order to more clearly understand the above objectives, features, and advantages of the present disclosure, the solutions of the present disclosure are further described below. It should be noted that, in the case of no conflict, the embodiments of the present disclosure and the features in the embodiments can be combined with each other.

A large number of specific details are set forth in the following description to fully understand the present disclosure, but the present disclosure can also be implemented in other manners different from those described herein; apparently, the embodiments described in the specification are only some embodiments of the present disclosure, rather than all of the embodiments.

A serverless architecture is a software design method that allows developers to build and run services without managing the underlying architecture system. A user-mode service is provided for a user. The user only needs to write function code that implements application logic, and then upload the function code to a serverless system. When it is detected that an event that triggers execution of the function code occurs, the serverless system allocates a plurality of computing nodes to the function code for executing a task related to the function code. The user does not need to be concerned about computing resource-level issues, so that a development by the user becomes more convenient, burden of the development by the user is reduced, and a better experience is provided to the user.

The serverless architecture is used in a plurality of fields such as general big data processing and distributed machine learning. For example, the serverless architecture may be applied to the field of graph computing and graph mining. For a computing task and a mining task of a large-scale graph with billions or even trillions of edges, a heavy task needs to be distributed to a large number of computing nodes. The inventors have found that in a serverless architecture distributed system in the field of graph computing and graph mining, fault tolerance is less considered as a basic capability. The lack of fault tolerance capability may lead to failure of an entire job once a node fails, and restarting the job needs to be executed from the beginning, which will affect the execution progress of the task in the serverless architecture distributed system. To this end, the present disclosure provides a serverless architecture distributed fault-tolerant system, which may be deployed in a physical cluster or in a cloud environment, and uses a fault-tolerant function as a basic capability, thereby reducing the impact of a failure of a node or the like on the execution progress of the task.

Specifically, an embodiment of the present disclosure provides a serverless architecture distributed fault-tolerant system. Referring to FIG. 1, FIG. 1 is an architecture diagram of a serverless architecture distributed fault-tolerant system according to some embodiments of the present disclosure.

The serverless architecture distributed fault-tolerant system 100 comprises a serverless architecture control module 101 and distributed architecture-based computing nodes, for example, a computing node 102 and a computing node 104. The serverless architecture control module 101 is in communication connection with each distributed architecture-based computing node. The distributed architecture-based computing nodes is configured to receive and execute an assigned target task.

The serverless architecture control module 101 is configured to monitor a working state of each distributed architecture-based computing node, and when a faulty computing node (assuming that the faulty computing node is the computing node 102) is monitored, construct a replica computing node 103 for the faulty computing node 102 based on a persistent storage unit 1021 in the faulty computing node 102, where the replica computing node 103 is configured to replace the faulty computing node 102 to continue to execute a target task undertaken by the faulty computing node 103; the persistent storage unit 1021 is configured to store graph data and state snapshot data corresponding to the target task, and the state snapshot data comprises intermediate state data generated during execution of the target task; and

the replica computing node 103 is configured to restore and continue to execute the target task based on the graph data and the state snapshot data corresponding to the target task that are stored in the persistent storage unit 1021.

In some embodiments, the distributed architecture-based computing nodes may be implemented based on a (container) pod(s). Each distributed architecture-based computing node comprises a proxy unit, a computing unit, and a persistent storage unit, and the proxy unit, the computing unit, and the persistent storage unit in a same computing node are all deployed in a same pod. In addition, the same pod may comprise one or more computing units, and each computing unit corresponds to one process. The proxy unit(s) in the pod is configured to control the one or more computing units.

The persistent storage unit may be implemented based on a persistent storage medium (such as an Optane persistent memory (PMEM)), may be implemented based on a hard disk (such as a solid-state drive (SSD)), or may be implemented based on a mixed storage design of a memory, a persistent storage medium, and a hard disk, and is configured to persistently store data, without affecting data storage due to a failure such as power failure. The computing unit (also referred to as a worker) refers to an application coupling entity that holds a computing resource and executes an assigned computing task.

In some embodiments, the persistent storage unit uses a hierarchical structure of a memory, a persistent storage medium, and a hard disk.

Specifically, the persistent storage unit is specifically configured to store the graph data and the state snapshot data corresponding to the target task in corresponding storage layers based on a descending order of priorities of three storage layers of the memory, the persistent storage medium, and the hard disk. The graph data and the state snapshot data corresponding to the target task that are stored in the persistent storage unit of each computing node may be different.

In some other embodiments, the persistent storage unit uses a hierarchical structure of a memory and a persistent storage medium.

Specifically, the persistent storage unit is specifically configured to store the graph data and the state snapshot data corresponding to the target task in corresponding storage layers based on a descending order of priorities of two storage layers of the memory and the persistent storage medium.

The embodiments of the present disclosure can perform fault-tolerant processing for a failure of a computing node implemented based on a container, to implement container-level fault tolerance at a resource scheduling level, thereby reducing the impact of the failure of the computing node on an execution progress of a task.

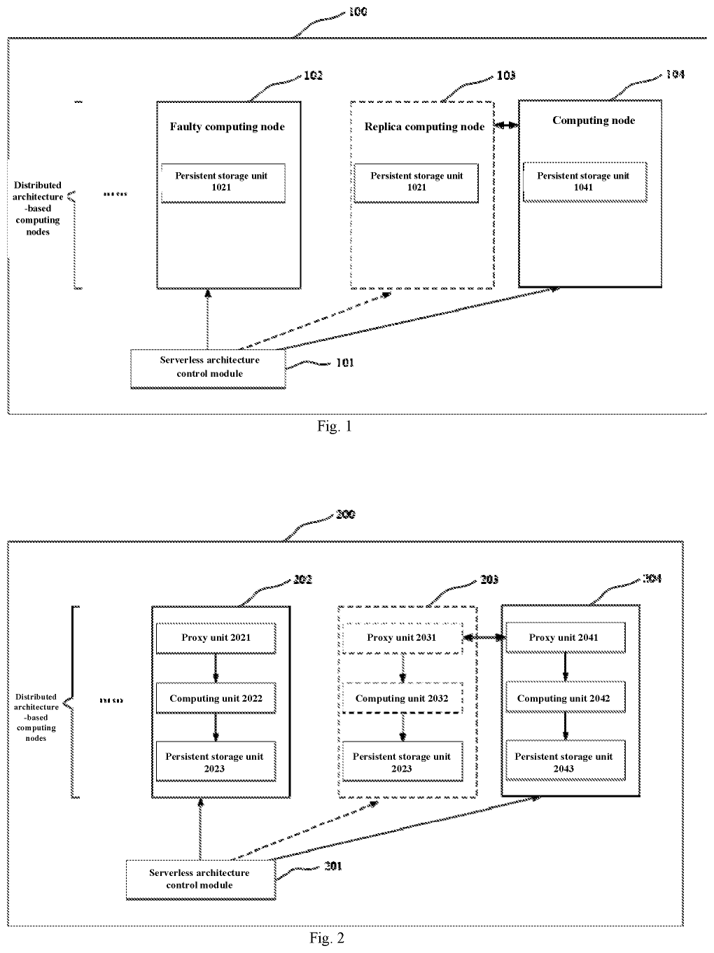

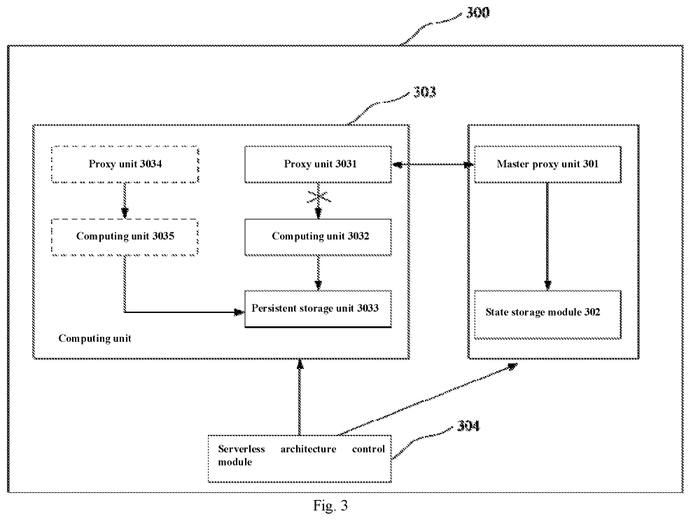

To facilitate further understanding of the foregoing serverless architecture distributed fault-tolerant system, some embodiments of the present disclosure provide an architecture diagram of another serverless architecture distributed fault-tolerant system, as shown in FIG. 2.

A serverless architecture distributed system 200 comprises a serverless architecture control module 201 and distributed architecture-based computing nodes, for example, computing nodes 202 and 204. Specifically, the computing node 202 may comprise a proxy unit 2021, a computing unit 2022, and a persistent storage unit 2023 that have a correspondence with each other.

The serverless architecture control module 201 is specifically configured to monitor a working state of the distributed architecture-based computing nodes, and in response to monitoring a faulty computing node (assuming that the faulty computing node is the computing node 202), construct a new proxy unit 2031 (which may be referred to as a first replica proxy unit) for a persistent storage unit 2023 in the faulty computing node 202.

The proxy unit 2031 is configured to construct a new computing unit 2032 (which may be referred to as a first replica computing unit) for the persistent storage unit 2023 in the faulty computing node 202, and the proxy unit 2031 controls the constructed computing unit 2032 to restore the execution of the target task based on the state snapshot data and the graph data corresponding to the target task that are stored in the persistent storage unit 2023 in the faulty computing node 202.

The constructed proxy unit 2031 and the computing unit 2032, and the persistent storage unit 2023 in the faulty computing node 202 are all in a same computing node, that is, a replica computing node 203. The replica computing node 203 is configured to replace the faulty computing node 202 to continue to execute the target task undertaken by the faulty computing node 202.

In some embodiments, the proxy unit, the computing unit, and the persistent storage unit in a same computing node have a same index identifier, and the proxy unit, the computing unit, and the persistent storage unit with the index identifier can be located through the index identifier. For example, the proxy unit, the computing unit, and the persistent storage unit in the same computing node have a same index identifier 1, and the proxy unit, the computing unit, and the persistent storage unit with the index identifier 1 can be located through the index identifier 1. Specifically, a correspondence between the proxy unit and the index identifier, a correspondence between the computing unit and the index identifier, and a correspondence between the persistent storage unit and the index identifier may be preset and stored.

In actual application, each computing unit is respectively connected to a persistent storage unit, and the computing unit reads, in advance from a remote file system (such as a Hadoop distributed file system (HDFS)), a data shard corresponding to the target task, and stores the data shard corresponding to the target task in the persistent storage unit, for subsequent execution of the target task. In the embodiments of the present disclosure, a separate persistent storage unit is connected to each computing unit instead of the persistent storage unit being shared by the computing units, so that resource contention can be reduced to a large extent.

The proxy unit may control a corresponding computing unit to execute the target task. Specifically, the proxy unit controls the computing unit to obtain, from the persistent storage unit, the graph data corresponding to the target task, and execute the target task.

In addition, the proxy unit controls the computing unit to periodically write state snapshot data generated during the execution of the target task into the corresponding persistent storage unit, to implement persistent storage of the state snapshot data, so that when a failure is subsequently monitored, an execution state of the target task can be restored based on the state snapshot data of the target task. The state snapshot data may also be referred to as checkpoint data, which is used to record execution state data of the target task, and a certain transient state of the target task can be restored based on the execution state data.

In some embodiments, each of the distributed architecture-based computing nodes comprises a proxy unit, a computing unit, and a persistent storage unit, the persistent storage unit is configured to store the graph data and the state snapshot data corresponding to the target task, and the state snapshot data comprises the intermediate state data generated during the execution of the target task.

In the embodiments of the present disclosure, the proxy units in the computing nodes are in communication connection, and the proxy units may synchronize calculation result data with each other based on negotiation communication, to jointly execute the target task.

In some embodiments, in response to monitoring the faulty computing node, the serverless architecture control module determines the persistent storage unit comprised in the faulty computing node, and constructs a new computing node (for example, a replica computing node) based on the persistent storage unit, to replace the faulty computing node to continue to execute the target task. In addition, the proxy unit in the new computing node may notify, based on the communication connection between the proxy units, another proxy unit to suspend the execution of the target task, and instruct the another proxy unit to synchronize the state snapshot data of the target task to the new computing node, so that the new computing node can restore execution of the target task instead of the faulty computing node.

Specifically, the proxy unit in the new computing node is specifically configured to restore the execution of the target task based on the state snapshot data, the graph data corresponding to the target task, and the state snapshot data from another computing node that are stored in the persistent storage unit in the computing node.

It should be noted that after determining to restore execution of the target task to a latest state, the new proxy unit may also notify, based on the communication connection between the proxy units, the another proxy unit that the target task can be continued to be executed.

Based on the foregoing embodiments, the serverless architecture distributed fault-tolerant system further comprises a master proxy unit. The master proxy unit is in communication connection with the proxy unit in the each of the distributed architecture-based computing nodes, and is configured to maintain a state of the proxy unit in the each of the distributed architecture-based computing nodes and store index information of the proxy unit in the each of the distributed architecture-based computing nodes.

FIG. 3 is a schematic diagram of another serverless architecture distributed fault-tolerant system according to an embodiment of the present disclosure. The serverless architecture distributed fault-tolerant system 300 comprises a serverless architecture control module 304, a master proxy unit 301, a state storage module 302, and a computing node 303. The master proxy unit 301 is in communication connection with the proxy unit in each computing node. The master proxy unit 301 uses the state storage module 302 to store index information of each proxy unit. Data synchronization and the like may be implemented based on negotiation communication between the master proxy unit and each proxy unit.

In addition, the master proxy unit is configured to monitor a working state of the proxy unit in each computing node, and in response to monitoring a faulty proxy unit (assuming that the faulty proxy unit is a proxy unit 3031 in a computing node 303), construct a replica proxy unit 3034 (which may be referred to as a second replica proxy unit) for the faulty proxy unit 3031.

The replica proxy unit 3034 is configured to construct a new computing unit 3035 (which may be referred to as a second replica computing unit) for a persistent storage unit 3033 corresponding to the faulty proxy unit 3031, and the replica proxy unit 3034 controls the computing unit 3035 to restore the execution of the target task based on the state snapshot data and the graph data of the target task that are stored in the persistent storage unit 3033.

Specifically, the faulty proxy unit 3031 may be a proxy unit in any computing node. Because the proxy unit 3031 fails, the corresponding computing unit 3032 is recycled. At this time, after the new proxy unit (for example, the proxy unit 3034) is created, the new proxy unit 3034 needs to create the new computing unit 3035.

In some embodiments, after the faulty proxy unit is monitored, the master proxy unit 301 notifies the proxy unit in each computing node to suspend execution of the assigned target task based on the communication connection with the proxy unit in each computing node, and in response to the execution of the target task being restored, notifies the proxy unit in another computing node to continue to execute the assigned target task.

In some embodiments, correspondences among the computing nodes, the proxy units, the computing units, and the persistent storage units that have same index identifiers may be separately pre-stored at each proxy unit, or may be separately stored in a state storage module 302 of the master proxy unit 301, to save storage resources of each proxy unit. Based on negotiation communication between the proxy units, required index information may be obtained from the state storage module 302 of the master proxy unit 301 based on a requirement.

The serverless architecture distributed fault-tolerant system provided in the embodiments of the present disclosure is an elastic fault-tolerant framework based on the proxy unit, which can support not only fault tolerance at a computing node level, but also fault tolerance at a proxy unit level, further reducing a probability that a failure in the serverless architecture distributed fault-tolerant system affects an execution progress of a task.

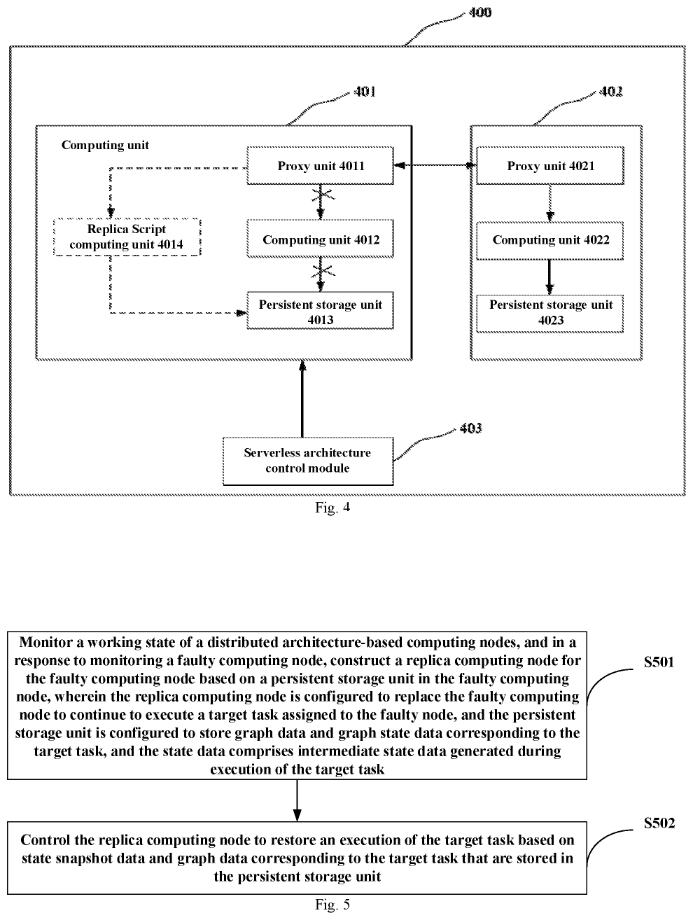

In addition, based on the foregoing embodiments, some embodiments of the present disclosure may further support fault tolerance at a computing unit level. Specifically, FIG. 4 is a schematic diagram of still another serverless architecture distributed fault-tolerant system according to some embodiments of the present disclosure.

The serverless architecture distributed fault-tolerant system 400 comprises distributed architecture-based computing nodes, for example, computing nodes 401 and 402. A proxy unit 4011 in the computing node 401 is configured to monitor a working state of a computing unit 4012 in the computing node 401, and in response to monitoring that the computing unit 4012 fails, create a replica computing unit 4014 (which may be referred to as a third replica proxy unit) for the faulty computing unit 4012, and control the replica computing unit 4014 by the proxy unit 4011 to restore the execution of the target task based on the state snapshot data and the graph data of the target task that are stored in a persistent storage unit 4013 corresponding to the faulty computing unit 4012.

In some embodiments, in response to determining that the computing unit 4012 corresponding to the proxy unit 4011 fails, the proxy unit 4011 obtains, based on a communication connection between the proxy units, index information stored in a state storage module of the master proxy unit, determines the persistent storage unit that has the same index identifier as the proxy unit 4011, that is, the persistent storage unit 4013, and creates the new computing unit 4014 for the persistent storage unit 4013 by the proxy unit 4011, to restore the execution of the target task. Specifically, the proxy unit 4011 may be a proxy unit in any computing node.

In some embodiments, in response to determining that the computing unit 4012 corresponding to the proxy unit 4011 fails, the proxy unit 4011 notifies, based on the communication connection between the proxy units, a proxy unit (for example, a proxy unit 4021 shown in FIG. 4) in another computing node to suspend the execution of the assigned target task, and in response to the execution of the target task being restored, notifies the proxy unit in the another computing node to continue to execute the assigned target task.

It can be seen that the serverless architecture distributed fault-tolerant system provided in the embodiments of the present disclosure can respectively support the fault-tolerant function from a distributed computing node level, a proxy unit level, and a computing unit level, thereby reducing the impact of a failure of a computing node, a proxy unit, a computing unit, or the like on a task execution progress.

The serverless architecture distributed fault-tolerant system provided in the embodiments of the present disclosure can perform fault-tolerant processing for a failure of a computing node, a failure of a proxy unit, and a failure of a computing unit that are implemented based on a container, to implement multi-dimensional fault tolerance from container-level fault tolerance at a resource scheduling level to proxy unit (Agent)-level fault tolerance at a distributed control plane, and then to computing unit (worker)-level fault tolerance of an application itself, thereby forming end-to-end fault-tolerant guarantee, ensuring an end-to-end fault-tolerant experience of a graph data processing application, and reducing occurrence of application error alarms and the like in an entire loop in which a user uses the graph data processing application. Based on the description of the foregoing embodiments of the serverless architecture distributed fault-tolerant system, the embodiments of the present disclosure further provide a serverless architecture distributed fault-tolerant method. Referring to FIG. 5, FIG. 5 is a flowchart of a serverless architecture distributed fault-tolerant method according to some embodiments of the present disclosure. The method comprises the following steps S501 and S502.

In step S501, a working state of distributed architecture-based computing nodes is monitored, and in response to a faulty computing node being monitored, a replica computing node is constructed for the faulty computing node based on a persistent storage unit in the faulty computing node.

The replica computing node is configured to replace the faulty computing node to continue to execute a target task assigned to the faulty computing node, the persistent storage unit is configured to store graph data and state snapshot data corresponding to the target task, and the state snapshot data comprises intermediate state data generated during execution of the target task.

The serverless architecture distributed fault-tolerant method provided in the embodiments of the present disclosure may be applied to the foregoing serverless architecture distributed fault-tolerant system. The serverless architecture distributed fault-tolerant system comprises a serverless architecture control module and distributed architecture-based computing nodes corresponding to a target task.

Each of the distributed architecture-based computing nodes in the embodiments of the present disclosure comprises a proxy unit, a computing unit, and a persistent storage unit, the persistent storage unit is configured to store the graph data and the state snapshot data corresponding to the target task, and the state snapshot data comprises the intermediate state data generated during the execution of the target task.

In some embodiments, the persistent storage unit uses a hierarchical structure of a memory, a persistent storage medium, and a hard disk. Specifically, the persistent storage unit is specifically configured to store the graph data and the state snapshot data corresponding to the target task in corresponding storage layers based on a descending order of priorities of three storage layers of the memory, the persistent storage medium, and the hard disk.

In some embodiments, the persistent storage unit uses a hierarchical structure of a memory and a persistent storage medium; specifically, the persistent storage unit is specifically configured to store the graph data and the state snapshot data corresponding to the target task in corresponding storage layers based on a descending order of priorities of two storage layers of the memory and the persistent storage medium.

In addition, the persistent storage medium in the embodiments of the present disclosure may comprise a persistent memory (PMEM) or the like.

In some embodiments, the constructing a replica computing node for a faulty computing node based on a persistent storage unit in the faulty computing node may specifically comprise: first constructing a proxy unit (which may be referred to as a first replica proxy unit) for the persistent storage unit in the faulty computing node, and then controlling the proxy unit to construct a computing unit (which may be referred to as a first replica computing unit) for the persistent storage unit in the faulty computing node, to implement construction of a new computing node of the faulty computing node.

Then, the constructed new computing unit may be controlled by the proxy unit to restore the execution of the target task based on the state snapshot data and the graph data corresponding to the target task that are stored in the persistent storage unit in the faulty computing node.

In some embodiments, the serverless architecture control module may determine, based on preset index relationships among the computing nodes, the proxy units, the computing units, and the persistent storage units, the persistent storage unit corresponding to the faulty computing node.

In actual application, the index relationships among the computing nodes, the proxy units, the computing units, and the persistent storage units may be preset and stored in each proxy unit, or may be preset and stored in the master proxy unit in the serverless architecture distributed fault-tolerant system. The serverless architecture control module may communicate with each proxy unit to determine the persistent storage unit corresponding to the faulty computing node.

In the embodiments of the present disclosure, after determining the persistent storage unit corresponding to the faulty computing node, in order to avoid system overheads of storing and reading graph data, the serverless architecture control module may keep the graph data stored in the persistent storage unit unchanged, but recreate a new computing node for processing the graph data in the persistent storage unit, that is, the replica computing node of the faulty computing node. Subsequently, the replica computing node may be used to process the graph data in the persistent storage unit, to restore the execution of the target task.

In some embodiments, a working state of the proxy unit in each computing node may be monitored by using a master proxy unit, and in response to a faulty proxy unit being monitored, a replica proxy unit (which may be referred to as a second replica proxy unit) is constructed for the faulty proxy unit, and then the replica proxy unit is controlled to construct the computing unit corresponding to the faulty proxy unit (which may be referred to as a second replica computing unit) for the persistent storage unit corresponding to the faulty proxy unit, and the constructed computing unit corresponding to the faulty proxy unit is controlled to restore the execution of the target task based on the state snapshot data and the graph data of the target task that are stored in the persistent storage unit corresponding to the faulty proxy unit.

The embodiments of the present disclosure can construct the replica proxy unit for the faulty proxy unit, to implement the fault-tolerant function at the proxy unit level, thereby reducing the impact on an execution progress of the target task.

In some embodiments, a proxy unit in a same computing node is configured to monitor a working state of a computing unit in the computing node. In response to the proxy unit monitoring that the computing unit fails, a replica computing unit (which may be referred to as a third replica computing unit) is created for the faulty computing unit, and then the replica computing unit is controlled to replace the faulty computing unit to restore the execution of the target task based on the state snapshot data and the graph data of the target task that are stored in the persistent storage unit in the same computing node.

In step S502, the replica computing node is controlled to restore the execution of the target task based on the state snapshot data and the graph data corresponding to the target task that are stored in the persistent storage unit.

In actual application, calculation result data, state snapshot data, and the like generated during the execution of the target task by each computing node may be synchronized to another computing node according to a preset period, so that the target task is completed cooperatively between the computing nodes.

In some embodiments, the constructed new computing unit may be controlled by the proxy unit to restore the execution of the target task based on the state snapshot data, the graph data corresponding to the target task that are stored in the persistent storage unit in the faulty computing node, and the state snapshot data from another computing node.

In some embodiments, based on a communication connection between the proxy units, the proxy unit in the faulty computing unit may notify another proxy unit to suspend execution of the target task.

When it is monitored that the execution of the target task is restored, the proxy unit in the another computing node may also be notified to continue to execute the assigned target task.

The serverless architecture distributed fault-tolerant method provided in the embodiments of the present disclosure can respectively support the fault-tolerant function from a distributed computing node level, a proxy unit level, and a computing unit level, thereby reducing the impact of a failure of a computing node, a proxy unit, a computing unit, or the like on an execution progress of a task.

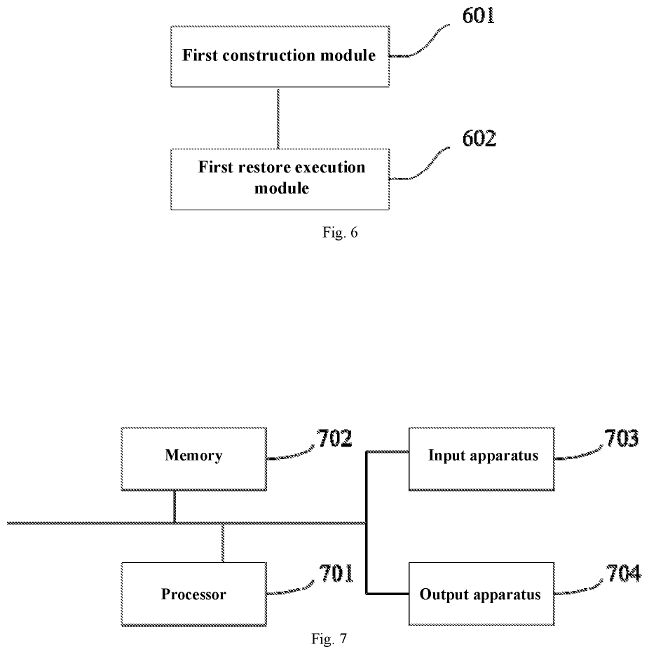

Based on the foregoing method embodiments, the present disclosure further provides a serverless architecture distributed fault-tolerant apparatus. Referring to FIG. 6, FIG. 6 is a schematic diagram of a structure of a serverless architecture distributed fault-tolerant apparatus according to an embodiment of the present disclosure. The apparatus comprises:

a first construction module 601, configured to monitor a working state of distributed architecture-based computing nodes, and in response to monitoring a faulty computing node, construct a replica computing node for the faulty computing node based on a persistent storage unit in the faulty computing node, wherein the replica computing node is configured to replace the faulty computing node to continue to execute a target task assigned to the faulty node, the persistent storage unit is configured to store graph data and state snapshot data corresponding to the target task, and the state snapshot data comprises intermediate state data generated during execution of the target task; and

a first restore execution module 602, configured to control the replica computing node to restore the execution of the target task based on the state snapshot data and the graph data corresponding to the target task that are stored in the persistent storage unit.

In some embodiments, the first construction module 601 comprises:

a first construction submodule, configured to construct a proxy unit (which may be referred to as a first replica proxy unit) for the persistent storage unit in the faulty computing node; and

a control submodule, configured to control the constructed proxy unit to construct a computing unit (which may be referred to as a first replica computing unit) for the persistent storage unit in the faulty computing node; and

correspondingly, the restore execution module is specifically configured to:

control, by using the proxy unit, the constructed computing unit to restore the execution of the target task based on the state snapshot data and the graph data corresponding to the target task that are stored in the persistent storage unit in the faulty computing node.

In some embodiments, each computing node comprises a proxy unit, a computing unit, and a persistent storage unit, the persistent storage unit is configured to store graph data and state snapshot data corresponding to the target task, and the state snapshot data comprises intermediate state data generated during execution of the target task; and the apparatus further comprises:

a second construction module, configured to monitor a working state of the proxy unit in each computing node by using a master proxy unit, and in response to monitoring a faulty proxy unit, construct a replica proxy unit (which may be referred to as a second replica proxy unit) for the faulty proxy unit; and

a second restore execution module, configured to control the replica proxy unit to construct the computing unit corresponding to the faulty proxy unit (which may be referred to as a second replica computing unit) for the persistent storage unit corresponding to the faulty proxy unit, and control the constructed computing unit corresponding to the faulty proxy unit to restore the execution of the target task based on the state snapshot data and the graph data of the target task that are stored in the persistent storage unit corresponding to the faulty proxy unit.

In some embodiments, each computing node comprises a proxy unit, a computing unit, and a persistent storage unit, the persistent storage unit is configured to store graph data and state snapshot data corresponding to the target task, and the state snapshot data comprises intermediate state data generated during execution of the target task; and the apparatus further comprises:

a third construction module, configured to create a replica computing unit for the faulty computing unit in response to the proxy unit monitoring that the computing unit fails; and

a third restore execution module, configured to control the replica computing unit to replace the faulty computing unit to restore the execution of the target task based on the state snapshot data and the graph data of the target task that are stored in the persistent storage unit.

In some embodiments, the apparatus further comprises:

a notification module, configured to notify, by using the proxy unit and based on a communication connection between the proxy units, another proxy unit to suspend execution of the target task; and in response to monitoring that the target task is restored and continued to be executed, notify the another proxy unit in another computing node to continue to execute the assigned target task.

In some embodiments, the first restore execution module is specifically configured to:

control, by using the proxy unit, the constructed computing unit to restore the execution of the target task based on the state snapshot data, the graph data corresponding to the target task that are stored in the persistent storage unit in the faulty computing node, and the state snapshot data from another computing node.

In some embodiments, the persistent storage unit uses a hierarchical structure of a memory, a persistent storage medium, and a hard disk; and

the persistent storage unit is specifically configured to store the graph data and the state snapshot data corresponding to the target task in corresponding storage layers based on a descending order of priorities of three storage layers of the memory, the persistent storage medium, and the hard disk.

In some embodiments, the persistent storage unit uses a hierarchical structure of a memory and a persistent storage medium; and

the persistent storage unit is specifically configured to store the graph data and the state snapshot data corresponding to the target task in corresponding storage layers based on a descending order of priorities of two storage layers of the memory and the persistent storage medium.

In some embodiments, the persistent storage medium comprises a persistent memory.

The serverless architecture distributed fault-tolerant apparatus provided in the embodiments of the present disclosure can respectively support the fault-tolerant function from a distributed computing node level, a proxy unit level, and a computing unit level, thereby reducing the impact of a failure of a computing node, a proxy unit, a computing unit, or the like on a task execution progress.

In addition to the foregoing method and apparatus, the embodiments of the present disclosure further provide a computer-readable storage medium storing instructions that, when executed on a terminal device, cause the terminal device to implement the serverless architecture distributed fault-tolerant method according to the embodiments of the present disclosure.

The embodiments of the present disclosure further provide a computer program product comprising a computer program/instructions that, when executed by a processor, cause the serverless architecture distributed fault-tolerant method according to the embodiments of the present disclosure to be implemented.

In addition, the embodiments of the present disclosure further provide a serverless architecture distributed fault-tolerant device. As shown in FIG. 7, the serverless architecture distributed fault-tolerant device may comprise:

a processor 701, a memory 702, an input apparatus 703, and an output apparatus 704. There may be one or more processors 701 in the serverless architecture distributed fault-tolerant device. One processor is used as an example in FIG. 7. In some embodiments of the present disclosure, the processor 701, the memory 702, the input apparatus 703, and the output apparatus 704 may be connected through a bus or in another manner, and FIG. 7 shows connection through a bus as an example.

The memory 702 may be configured to store a software program and a module. The processor 701 executes various functional applications and data processing of the serverless architecture distributed fault-tolerant device by running the software program and the module that are stored in the memory 702. The memory 702 may mainly comprise a program storage area and a data storage area, where the program storage area may store an operating system, an application program required for at least one function, and the like. In addition, the memory 702 may comprise a high-speed random access memory, and may further comprise a non-volatile memory, for example, at least one magnetic disk storage device, a flash memory device, or another volatile solid-state storage device. The input apparatus 703 may be configured to receive inputted numeric or character information, and generate a signal input related to user setting and function control of the serverless architecture distributed fault-tolerant device.

Specifically, in this embodiment, the processor 701 loads, according to the following instructions, an executable file corresponding to a process of one or more application programs into the memory 702, and runs the application program that is stored in the memory 702 by the processor 701, to implement various functions of the foregoing serverless architecture distributed fault-tolerant device.

It should be noted that in this document, relation terms such as “first” and “second” are only used to distinguish one entity or operation from another entity or operation, but do not necessarily require or imply that there is any such actual relation or order between these entities or operations. Moreover, the terms “comprise”, “comprise”, or any other variant thereof are intended to cover non-exclusive inclusion, so that a process, a method, an article, or an apparatus that comprises a list of elements not only comprises those elements but also comprises other elements not expressly listed, or further comprises elements inherent to such process, method, article, or apparatus. Without more restrictions, an element defined by the statement “comprising a/an . . . ” does not exclude the presence of another identical element in the process, method, article, or apparatus that comprises the element.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A serverless architecture distributed fault-tolerant system, comprising:
a serverless architecture control module and distributed architecture-based computing nodes, wherein:
the serverless architecture control module is in communication connection with the distributed architecture-based computing nodes; the distributed architecture-based computing nodes are configured to receive and execute an assigned target task;
the serverless architecture control module is configured to monitor a working state of the distributed architecture-based computing nodes, and in a response to monitoring a faulty computing node, construct a replica computing node for the faulty computing node based on a persistent storage unit in the faulty computing node;
the replica computing node is configured to replace the faulty computing node to continue to execute a target task assigned to the faulty computing node;
the persistent storage unit is configured to store graph data and state snapshot data corresponding to the target task, and the state snapshot data comprises intermediate state data generated during execution of the target task; and
the replica computing node is configured to restore an execution of the target task based on the graph data and the state snapshot data corresponding to the target task that are stored in the persistent storage unit.

2. The serverless architecture distributed fault-tolerant system according to claim 1, wherein:
the serverless architecture control module is configured to construct a proxy unit for the persistent storage unit in the faulty computing node; and
the constructed proxy unit is configured to construct a computing unit for the persistent storage unit in the faulty computing node, the replica computing node comprises the constructed computing unit and the proxy unit, and control the constructed computing unit to restore the execution of the target task based on the state snapshot data and the graph data corresponding to the target task that are stored in the persistent storage unit in the faulty computing node.

3. The serverless architecture distributed fault-tolerant system according to claim 1, wherein each of the distributed architecture-based computing nodes comprises a proxy unit, a computing unit, and a persistent storage unit, the persistent storage unit is configured to store the graph data and the state snapshot data corresponding to the target task, and the state snapshot data comprises the intermediate state data generated during the execution of the target task, and the system further comprises:
a master proxy unit, wherein the master proxy unit is in communication connection with the proxy unit in the each of the distributed architecture-based computing nodes;
the master proxy unit is configured to monitor a working state of the proxy unit in the each of the distributed architecture-based computing nodes, and in response to monitoring a faulty proxy unit, construct a replica proxy unit for the faulty proxy unit; and
the replica proxy unit is configured to construct a computing unit corresponding to the faulty proxy unit for the persistent storage unit corresponding to the faulty proxy unit, and control the constructed computing unit corresponding to the faulty proxy unit to restore the execution of the target task based on the state snapshot data and the graph data of the target task that are stored in the persistent storage unit corresponding to the faulty proxy unit.

4. The serverless architecture distributed fault-tolerant system according to claim 1, wherein each of the distributed architecture-based computing nodes comprises a proxy unit, a computing unit, and a persistent storage unit, the persistent storage unit is configured to store the graph data and the state snapshot data corresponding to the target task, and the state snapshot data comprises the intermediate state data generated during the execution of the target task; and
the proxy unit is configured to create a replica computing unit for a faulty computing unit, and in response to the proxy unit monitoring the faulty computing unit, control the replica computing unit to replace the faulty computing unit to restore the execution of the target task based on the state snapshot data and the graph data of the target task that are stored in the persistent storage unit corresponding to the faulty computing unit.

5. The serverless architecture distributed fault-tolerant system according to claim 2, wherein:
the constructed proxy unit is further configured to notify, based on a communication connection between proxy units, a proxy unit in another computing node to suspend execution of the assigned target task, and in response to restoring the execution of the target task, notify the proxy unit in the another computing node to continue to execute the assigned target task.

6. The serverless architecture distributed fault-tolerant system according to claim 2, wherein:
the constructed proxy unit is specifically configured to construct a computing unit for the persistent storage unit in the faulty computing node, and control the constructed computing unit to restore the execution of the target task based on the state snapshot data, the graph data corresponding to the target task, and the state snapshot data from another computing node that are stored in the persistent storage unit in the faulty computing node.

7. The serverless architecture distributed fault-tolerant system according to claim 1, wherein the persistent storage unit uses a hierarchical structure of a memory, a persistent storage medium, and a hard disk, and
the persistent storage unit is specifically configured to store the graph data and the state snapshot data corresponding to the target task in corresponding storage layers based on a descending order of priorities of three storage layers of the memory, the persistent storage medium, and the hard disk.

8. The serverless architecture distributed fault-tolerant system according to claim 1, wherein the persistent storage unit uses a hierarchical structure of a memory and a persistent storage medium, and
the persistent storage unit is specifically configured to store the graph data and the state snapshot data corresponding to the target task in corresponding storage layers based on a descending order of priorities of two storage layers of the memory and the persistent storage medium.

9. The serverless architecture distributed fault-tolerant system according to claim 7, wherein the persistent storage medium comprises a persistent memory.

10. The serverless architecture distributed fault-tolerant system according to claim 1, wherein each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task; and the system further comprises a master proxy unit, wherein the master proxy unit is in communication connection with the proxy unit in each of the distributed architecture-based computing nodes;
the master proxy unit is configured to monitor a working state of the proxy unit in the each of the distributed architecture-based computing nodes, and in response to monitoring a faulty proxy unit, construct a replica proxy unit for the faulty proxy unit; and
the replica proxy unit is configured to construct a computing unit corresponding to the faulty proxy unit for the persistent storage unit corresponding to the faulty proxy unit, and control the constructed computing unit corresponding to the faulty proxy unit to restore the execution of the target task based on the state snapshot data and the graph data of the target task that are stored in the persistent storage unit corresponding to the faulty proxy unit; and
the proxy unit is configured to create a replica computing unit for a faulty computing unit, and in response to monitoring the faulty computing unit, control the replica computing unit to replace the faulty computing unit to restore the execution of the target task based on the state snapshot data and the graph data of the target task that are stored in the persistent storage unit.

11. A serverless architecture distributed fault-tolerant method, comprising:
monitoring a working state of distributed architecture-based computing nodes, and in a response to monitoring a faulty computing node, constructing a replica computing node for the faulty computing node based on a persistent storage unit in the faulty computing node, wherein the replica computing node is configured to replace the faulty computing node to continue to execute a target task assigned to the faulty node, the persistent storage unit is configured to store graph data and state snapshot data corresponding to the target task, and the state snapshot data comprises intermediate state data generated during execution of the target task; and
controlling the replica computing node to restore an execution of the target task based on the state snapshot data and the graph data corresponding to the target task that are stored in the persistent storage unit.

12. The serverless architecture distributed fault-tolerant method according to claim 11, wherein the constructing a replica computing node for the faulty computing node based on a persistent storage unit in the faulty computing node comprises:
constructing a proxy unit for the persistent storage unit in the faulty computing node; and
controlling the constructed proxy unit to construct a computing unit for the persistent storage unit in the faulty computing node; and
the controlling the replica computing node to restore the execution of the target task based on the state snapshot data and the graph data corresponding to the target task that are stored in the persistent storage unit comprises:
controlling, by using the constructed proxy unit, the constructed computing unit to restore the execution of the target task based on the state snapshot data and the graph data corresponding to the target task that are stored in the persistent storage unit in the faulty computing node.

13. The serverless architecture distributed fault-tolerant method according to claim 11, wherein each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task, and the method further comprises:
monitoring a working state of the proxy unit in the each of the distributed architecture-based computing nodes by using a master proxy unit, and in response to monitoring a faulty proxy unit, constructing a replica proxy unit for the faulty proxy unit; and
controlling the replica proxy unit to construct the computing unit corresponding to the faulty proxy unit for the persistent storage unit corresponding to the faulty proxy unit, and controlling the constructed computing unit corresponding to the faulty proxy unit to restore the execution of the target task based on the state snapshot data and the graph data of the target task that are stored in the persistent storage unit corresponding to the faulty proxy unit.

14. The serverless architecture distributed fault-tolerant method according to claim 11, wherein each of the distributed architecture-based computing nodes comprises a proxy unit, a computing unit, and a persistent storage unit, the persistent storage unit is configured to store the graph data and the state snapshot data corresponding to the target task, and the state snapshot data comprises intermediate state data generated during the execution of the target task, and the method further comprises:
in response to a proxy unit in a computing node monitoring faulty computing unit in the computing node, creating a replica computing unit for the faulty computing unit; and
controlling the replica computing unit to replace the faulty computing unit to restore the execution of the target task based on the state snapshot data and the graph data of the target task that are stored in the persistent storage unit in the computing node.

15. The serverless architecture distributed fault-tolerant method according to claim 12, further comprising:
notifying, by using the constructed proxy unit and based on a communication connection between proxy units, another proxy unit to suspend execution of the target task; and
in response to monitoring that the execution of the target task is restored, notifying the proxy unit in the another computing node to continue to execute the assigned target task.

16. The serverless architecture distributed fault-tolerant method according to claim 12, wherein the controlling, by using the constructed proxy unit, the constructed computing unit to restore the execution of the target task based on the state snapshot data and the graph data corresponding to the target task that are stored in the persistent storage unit in the faulty computing node comprises:
controlling, by using the constructed proxy unit, the constructed computing unit to restore the execution of the target task based on the state snapshot data, the graph data corresponding to the target task that are stored in the persistent storage unit in the faulty computing node, and the state snapshot data from another computing node.

17. The serverless architecture distributed fault-tolerant method according to claim 11, further comprising:
monitoring a working state of a proxy unit in each of the distributed architecture-based computing nodes by using a master proxy unit, and in response to monitoring a faulty proxy unit, constructing a replica proxy unit for the faulty proxy unit; controlling the replica proxy unit to construct a computing unit corresponding to the faulty proxy unit for the persistent storage unit corresponding to the faulty proxy unit, and controlling the constructed computing unit corresponding to the faulty proxy unit to restore the execution of the target task based on the state snapshot data and the graph data of the target task that are stored in the persistent storage unit corresponding to the faulty proxy unit; and
in response to a proxy unit in a computing node monitoring a faulty computing unit in the computing node, creating a replica computing unit for the faulty computing unit; and controlling the replica computing unit to replace the faulty computing unit to restore the execution of the target task based on the state snapshot data and the graph data of the target task that are stored in the persistent storage unit in the faulty computing node.

18. (canceled)

19. A non-transitory computer-readable storage medium, wherein instructions are stored in the computer-readable storage medium, and when the instructions are run on a terminal device, the terminal device is caused to implement the serverless architecture distributed fault-tolerant method according to claim 11.

20. A distributed graph data processing device, comprising: a memory, a processor, and a computer program stored on the memory and executable on the processor, wherein computer program when the processor executes the computer program, causes the processor to:
monitor a working state of distributed architecture-based computing nodes, and in a response to monitoring a faulty computing node, construct a replica computing node for the faulty computing node based on a persistent storage unit in the faulty computing node, wherein the replica computing node is configured to replace the faulty computing node to continue to execute a target task assigned to the faulty node, the persistent storage unit is configured to store graph data and state snapshot data corresponding to the target task, and the state snapshot data comprises intermediate state data generated during execution of the target task; and
control the replica computing node to restore an execution of the target task based on the state snapshot data and the graph data corresponding to the target task that are stored in the persistent storage unit.

21. (canceled)

22. (canceled)

23. The distributed graph data processing device according to claim 20, wherein the constructing a replica computing node for the faulty computing node based on a persistent storage unit in the faulty computing node comprises:
constructing a proxy unit for the persistent storage unit in the faulty computing node; and
controlling the constructed proxy unit to construct a computing unit for the persistent storage unit in the faulty computing node; and
the controlling the replica computing node to restore the execution of the target task based on the state snapshot data and the graph data corresponding to the target task that are stored in the persistent storage unit comprises:
controlling, by using the constructed proxy unit, the constructed computing unit to restore the execution of the target task based on the state snapshot data and the graph data corresponding to the target task that are stored in the persistent storage unit in the faulty computing node.
